(19) United States
(12) Patent Application Publication
(10) Pub. No.: US 2018/0215197 A1
(43) Pub. Date: Aug. 2, 2018

(54) Vehicle Wheel Cover

(71) Applicant: Billy D. Williams, Oklahoma City, OK (US)

(72) Inventor: Billy D. Williams, Oklahoma City, OK (US)

(21) Appl. No.: 15/698,066

(22) Filed: Sep. 7, 2017

Related U.S. Application Data
(60) Provisional application No. 62/452,780, filed on Jan. 31, 2017.

(51) Int. Cl. B60B 7/06; B60B 7/10; B60B 7/04

(52) U.S. Cl. CPC B60B 7/063; B60B 7/04; B60B 7/10

(57) ABSTRACT

An apparatus for protecting a wheel designed to completely cover a wheel. It includes an attachment ring with clips that allow the wheel cover to be snapped onto a wheel and a protective band of rubber that covers the wheel edge of a sidewall thus preventing any external debris during normal use from getting to the wheel. Additionally, the wheel cover and protective band protect the wheel from cleaning chemicals when the vehicle is being detailed.

### CROSS-REFERENCE TO RELATED APPLICATION

The present application is related to and claims priority from prior provisional application Ser. No. 62/452,780, filed Jan. 31, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of covering devices and more specifically relates to an improved vehicle wheel cover.

### 2. DESCRIPTION OF THE RELATED ART

A hubcap, rim, wheel cover of wheel trim is a decorative disk on an automobile wheel that covers at least a central portion of the wheel, called the hub. A hubcap is technically the small cover of the center of the wheel, while a wheel cover is usually a decorative metal or plastic disk that that snaps or bolts onto and covers the entire face of the wheel. Cars with stamped steel wheels often use a full wheel cover that conceals the entire wheel. Cars with alloy wheels or styled steel wheels generally use smaller hubcaps, sometimes called center caps. Alternately, a wheel cover refers to an accessory covering an entire wheel.

A wheel cover also has the functional use of protecting wheels from unwanted materials while a vehicle is under normal operation and when a user decides to wash the vehicle using high pressure water techniques. The wheel cover is intended to protect a wheel from cleaning solutions used on tires to clean and treat the tires.

Various attempts have been made to solve the above-mentioned problems such as those found in U.S. Pat. No. 7,374,248 to Anthony J. Clayton; U.S. Pat. No. 6,598,942 to Curtis C. Williams; U.S. Pat. No. 6,116,415 to Michael Rastelli; U.S. Publication No. 2006/0226697 to Judith Samson, et al; and U.S. Publication No. 2009/0014107 to William Martin, et al. This prior art is representative of covering devices. None of the above inventions and patents, taken either singly or in combination, is seen to describe the invention as claimed.

Ideally, an improved vehicle wheel cover should provide protective coverage of a vehicle's wheel and, yet would operate reliably and be manufactured at a modest expense. Thus, a need exists for a reliable improved vehicle wheel cover to avoid the above-mentioned problems.

### BRIEF SUMMARY OF THE INVENTION

In view of the foregoing disadvantages inherent in the known covering devices art, the present invention provides a novel improved vehicle wheel cover. The general purpose of the present invention, which will be described subsequently in greater detail is to provide a covering for a vehicle wheel to prevent external elements such as particles of dirt, water, cleaning solutions used during washing and detailing of a vehicle, and the like from being embedded on a wheel.

An improved vehicle wheel cover for use in protecting a wheel of a vehicle is disclosed herein, in a preferred embodiment, comprising a wheel cover adapted to envelope and protect a wheel disc from exterior elements, an attachment ring adapted to be secured to a wheel rim, a flap adapted to cover an edge of a tire, and a plurality of clips adapted to removably secure the wheel cover to a wheel rim.

The wheel cover, formed from plastic material, comprises a covering surface available in a variety of colors having a thickness of approximately one eighth of an inch, an outside edge, and a center point raised approximately one half inch in relation to the outside edge of the covering surface. The wheel cover is formed having a circular shape.

The attachment ring, formed from metal, includes an attachment edge which is fixedly attached to the outside edge of the covering surface via an adhesive.

The flap, formed from rubber material, is formed as a disc having a width of approximately two inches. The flap includes a first edge which is attached to the attachment ring via adhesive. The flap further includes a second edge adapted to overlap a sidewall edge of a tire.

The plurality of clips equals four individual clips equally spaced around the attachment ring at each of a clip connection location. Each of the plurality of clips, formed from metal having a substantially U shape, are fixedly attached to the attachment ring via adhesive at each of clip connection locations. The wheel cover is adapted to be removably attached to a wheel rim by snapping each of the plurality of clips into position on a wheel rim.

Each of the wheel cover, the attachment ring, and the flap are manufactured in a variety of sizes to thereby be adapted to be used upon vehicle wheels of different sizes.

The present invention holds significant improvements and serves as an improved vehicle wheel cover. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an improved vehicle wheel cover constructed and operative according to the teachings of the present invention.

FIG. 1 shows a perspective view illustrating an improved vehicle wheel cover in an in-use condition according to an embodiment of the present invention.

FIG. 2 is a perspective view illustrating an improved vehicle wheel cover according to an embodiment of the present invention of FIG. 1.

FIG. 3 is a perspective view illustrating an improved vehicle wheel cover according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a covering device and more particularly to an improved vehicle wheel cover as used to improve the ability to cover a vehicle wheel to prevent external elements such as particles of dirt, water, cleaning solutions used during washing and detailing of a vehicle, and the like from being embedded on a wheel.

Generally speaking, an improved vehicle wheel cover is a protective wheel cover designed to completely cover a wheel. It includes an attachment ring with clips that allow the wheel cover to be snapped onto a wheel, and a protective band of rubber that covers the wheel edge of a sidewall thus preventing any external debris during normal use from getting to the wheel. Additionally, the wheel cover and protective band protect the wheel from cleaning chemicals when the vehicle is being detailed.

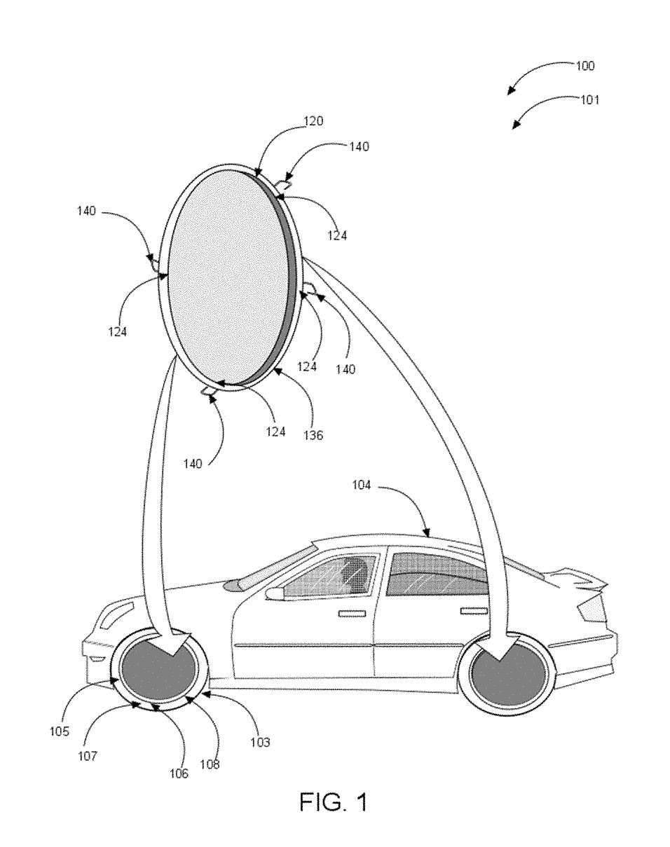

Referring to the drawings by numerals of reference there is shown in FIG. 1, a perspective view illustrating improved vehicle wheel cover 100 in an in-use condition 101 according to an embodiment of the present invention.

Improved vehicle wheel cover 100 for use in protecting wheel 103 of vehicle 104 is disclosed herein, in a preferred embodiment, comprising wheel cover 110 adapted to envelope and protect wheel disc 105 from exterior elements, attachment ring 120 adapted to be secured to wheel rim 106, flap 130 adapted to cover an edge of tire 107, and plurality of clips 140 adapted to removably secure wheel cover 110 to wheel rim 106.

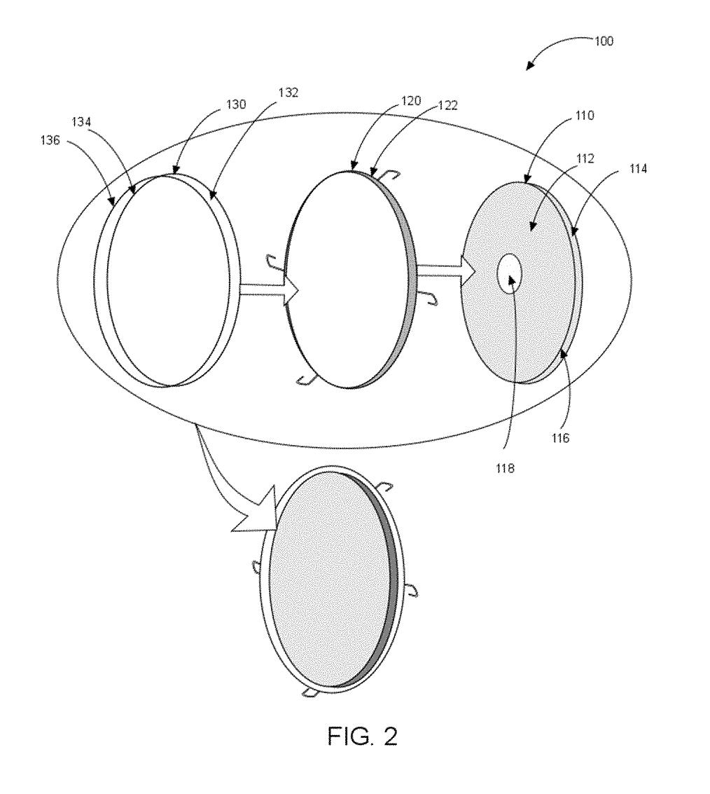

Referring now to FIG. 2, a perspective view illustrating improved vehicle wheel cover 100 according to an embodiment of the present invention of FIG. 1

Wheel cover 110, formed from plastic material, comprises covering surface 112, available in a variety of colors having thickness 114 of approximately one eighth of an inch, outside edge 116, and center point 118 raised approximately one half inch in relation to outside edge 116 of covering surface 112. Wheel cover 110 is formed having a circular shape. Alternately, wheel cover 110 may be formed of any suitable material and may or may not include center point 118.

Attachment ring 120, formed from metal, includes attachment edge 122 which is fixedly attached to outside edge 116 of covering surface 112 via an adhesive. Alternately, attachment ring 120 may be formed from any suitable material and be attached to outside edge 116 via any suitable attachment means.

Flap 130, formed from rubber material, is formed as a disc having width 132 of approximately two inches. Flap 130 includes first edge 134 which is attached to attachment ring 120 via adhesive. Flap 130 further includes second edge 136 adapted to overlap a sidewall edge 108 of tire 107. Alternately, flap 130 may be formed from any suitable material able to meet the criteria of covering sidewall edge 108 of tire 107.

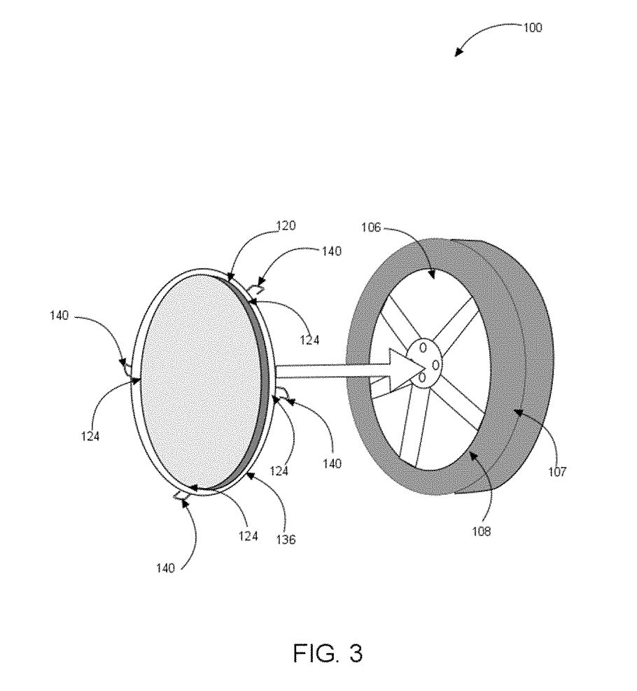

Referring now to FIG. 3, a perspective view illustrating improved vehicle wheel cover 100 according to an embodiment of the present invention of FIG. 1.

Plurality of clips 140 equals four individual clips equally spaced around attachment ring 120 at each of clip connection location 124. Each of plurality of clips 140, formed from metal having a substantially U shape, are fixedly attached to attachment ring 120 via adhesive at each of clip connection locations 124. Wheel cover 110 is adapted to be removably attached to wheel rim 106 by snapping each of plurality of clips 140 into position on wheel rim 106. Second edge 136 of flap 130 is adapted to overlap a sidewall edge 108 of tire 107. Alternately, plurality of clips 140 may be formed of any suitable material having any suitable shape. Alternately, wheel cover 110 may be attached to wheel 103 of vehicle 104 via any suitable attachment means.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved vehicle wheel cover for use in protecting a wheel of a vehicle comprising:
a wheel cover adapted to envelope and protect a wheel disc from exterior elements comprising;
a covering surface having a thickness;
an outside edge; and
a center point;
an attachment ring having an attachment edge, said attachment ring adapted to be secured to a wheel rim;
a flap having a width, a first edge and a second edge, said flap adapted to cover an edge of a tire; and
a plurality of clips adapted to removably secure said wheel cover to a wheel rim;
wherein said attachment edge of said attachment ring is fixedly attached to said outside edge of said wheel covering;
wherein said flap is fixedly attached to said attachment ring via said first edge of said flap; and
wherein each of said plurality of clips are fixedly attached to said attachment ring at a clip connection location.

2. The improved vehicle wheel cover of claim 1 wherein said covering surface is formed having a circular shape.

3. The improved vehicle wheel cover of claim 1 wherein said thickness of said covering surface is approximately one eighth of an inch.

4. The improved vehicle wheel cover of claim 1 wherein said center point of said wheel cover is raised approximately one half inch in relation to said outside edge of said covering surface.

5. The improved vehicle wheel cover of claim 1 wherein said covering surface is formed from plastic material.

6. The improved vehicle wheel cover of claim 1 wherein said attachment ring is formed from metal.

7. The improved vehicle wheel cover of claim 1 wherein said attachment ring is fixedly attached to said outside edge of said covering surface via an adhesive.

8. The improved vehicle wheel cover of claim 1 wherein said flap is formed from rubber material.

9. The improved vehicle wheel cover of claim 1 wherein said flap is formed as a disc having said width of approximately two inches.

10. The improved vehicle wheel cover of claim 1 wherein said first edge of said flap is attached to said attachment ring via said adhesive.

11. The improved vehicle wheel cover of claim 1 wherein said second edge of said flap is adapted to overlap a sidewall edge of a tire.

12. The improved vehicle wheel cover of claim 1 wherein said plurality of clips equals four individual clips.

13. The improved vehicle wheel cover of claim 12 wherein each of said plurality of clips are equally spaced around said attachment ring at each of said clip connection location.

14. The improved vehicle wheel cover of claim 13 wherein each of said plurality of clips are fixedly attached to said attachment ring via said adhesive at each of said clip connection location.

15. The improved vehicle wheel cover of claim 1 wherein said wheel cover is adapted to be removably attached to a wheel rim by snapping each of said plurality of clips into position on a wheel rim.

16. The improved vehicle wheel cover of claim 1 wherein each of said wheel cover, said attachment ring, and said flap are manufactured in a variety of sizes to thereby be adapted to be used upon vehicle wheels of different sizes.

17. The improved vehicle wheel cover of claim 1 wherein each of said plurality of clips is formed from metal having a substantially U shape.

18. The improved vehicle wheel cover of claim 1 wherein said covering surface is available is a variety of colors.
